(19) United States
(12) Patent Application Publication
(10) Pub. No.: US 2012/0275983 A1
(43) Pub. Date: Nov. 1, 2012

(54) SILICON NITRIDE BASED CRUCIBLE

(76) Inventors: Håvard Sørheim, Trondheim (NO); Arve Solheim, Tiller (NO); Egbert Van De Schootbrugge, Jonsvatnet (NO)

(21) Appl. No.: 13/512,879

(22) PCT Filed: Dec. 22, 2010
(86) PCT No.: PCT/NO2010/000483

§ 371 Date: Jul. 18, 2012

(30) Foreign Application Priority Data
Dec. 22, 2009 (NO) 2009 3584

(51) Int. Cl. C01B 21/068

(52) U.S. Cl. 423/344

(57) ABSTRACT

A reusable silicon nitride containing crucible is described. The crucible contains boron (B) or a boron containing compound and phosphorous (P) or a phosphorous containing compound. Use of the crucible for crystallizing silicon is also described.

The present invention relates to a reusable silicon nitride containing crucible and use of the reusable silicon nitride containing crucibles for crystallizing silicon.

### BACKGROUND

Fused silica and quartz crucibles are the most commonly used crucibles for the production of crystalline silicon ingots for solar cell purposes. These crucibles can only be used once and therefore contribute to high production cost. Crucibles are needed to crystallize silicon from which solar cells can be produced. The advantages of silicon nitride containing crucibles are that they are reusable and have high potential to reduce the production cost of solar cells. The reusability of the crucible has been proven. Electricity produced from solar cells are today much more expensive than conventional electricity. It is therefore very important for the solar industry to reduce the production cost of solar cells. A new reusable silicon nitride based crucible could contribute to this. A silicon nitride based crucible must not only be reusable, but also give better or equal silicon ingot quality compared to standard fused silica or quartz crucibles. This patent relates to the quality of silicon ingots prodused in a silicon nitride based crucible.

From patent NO317080 it is known a method to produce a reusable silicon nitride crucible. It was used a silicon powder called Silgrain® produced by Elkem AS, as raw material for the production of crucible. A silicon nitride crucible produced from the same raw material has now been tested by growing a multicrystalline ingot in this crucible. Surprisingly, the silicon ingot contained much higher content of both boron and phosphorous than expected. The silicon ingot had normal levels of elements like Fe, Al and Ca. The relative high content of B and P in the ingot caused a large deviation from the expected resistivity in the silicon ingot. A silicon ingot for the purpose of producing solar cells needs a specific resistivity in order to give good solar cell performance.

The object of the present invention is to provide a satisfactory ingot quality for the production of solar cells and wafers. Further, the object of the present invention is to prepare reusable silicon nitride based crucibles which are meant to replace the standard fused silica crucibles. Standard fused silica crucibles are hereinafter referred to as the reference.

### SUMMARY OF THE INVENTION

The present invention provides a reusable silicon nitride containing crucible for crystallizing silicon, wherein the crucible comprises at least one of the following: a boron or a boron containing compound in a concentration of <19 ppmw; and further at least one of the following: a phosphorous or a phosphorous containing compound in a concentration of <3.7 ppmw.

Further, the invention relates to use of a silicon nitride crucibles comprising at least one of the following: a boron (B) or a boron containing compound in a concentration of <19 ppmw; and further a phosphorous (P) or a phosphorous containing compound in a concentration of <3.7 ppmw, for crystallizing silicon.

### DETAILED DESCRIPTION OF THE INVENTION

The common raw materials for preparing silicon nitride containing crucibles are silicon, silicon carbide and silicon nitride. These raw materials are available in different qualities having different levels of impurities. Elements that are commonly present are Al, Ca, Fe, Ti, B and P.

Higher purity silicon nitride based crucibles will give less contamination to the ingot compared to standard fused silica and quartz crucibles mainly due to lower content of impurities. Silicon nitride based crucibles have also different material properties compared to fused silica and quartz crucibles. They contain mostly nitride compound impurities and do not soften at high temperature. Fused silica and quartz crucibles contain mainly impurities in form of oxide compounds and these crucibles soften at high temperature.

A crucible is always coated with a silicon nitride powder so that the crucible is never in direct contact with silicon. Any contamination from the crucible must diffuse from the crucible and through the coating. Volatile compounds can diffuse fast. Solid compounds must diffuse according to solid-solid diffusion which is much slower compared to gas diffusion. Fused silica and quartz crucibles have probably higher content of volatile compounds compared to a silicon nitride based crucible due to the presence of oxide compounds and that they soften at high temperature.

A coating covering at least parts of the crucibles has also resulted in contamination of the ingot. Higher purity coatings do give higher quality ingots. The effects of using upgraded materials for coating has been discussed by E. Olsen et.al: “Silicon Nitride Coating and Crucible-Effects of Using Upgraded Materials in the Casting of Multicrystalline Silicon Ingots”, Progress in Photovoltaics (2008), 16(2), 93-100. At some point the contamination from the coating will dominate the contamination from the crucible. Then it will be necessary to improve the coating.

Use of high purity silicon raw materials could be a challenge in order to be able to produce good quality crucibles. Pure silicon is known to react slowly with nitrogen, and thus, it can be difficult to achieve high conversion. Some level of impurities, like Fe, Al, Ca and Zr may improve the nitridation.

It is believed that B and P in the silicon nitride crucible are likely to be present as oxides. B and P oxides have relative high vapour pressure at 1400-1500° C. which is the temperature for melting silicon in the crucible. The contamination of B and P of the Si-ingot could be due to the presence of volatile B and P compounds. Other elements as Fe, Al, Ca and Ti do not contaminate the Si-ingot although present at much higher concentrations compared to B and P. It has been found that the B content in a silicon nitride based crucible must be below 19 ppmw in order not to give any significant contamination to the Si-ingot. Preferably, the content of B is <1 ppmw. Further, the content of P in a silicon nitride based crucible must be below 3.7 ppmw in order to not give any significant contamination of the Si-ingot. Preferably, the content of P is <0.5 ppmw.

The B and P compounds in the crucible must have different properties compared to other elements present since they give contamination to the silicon ingot although present at relative low concentrations. A crucible of the same type as above was heated to 1400-1500 degree Celsius. The B and P content in the crucible were significant reduced after this treatment. The content of other elements like Fe, Al and Ca were not reduced. This indicates that B and P compounds are volatile at these temperatures which are the temperature of use of the crucible for production of silicon ingots.

It can be very difficult to predict which content of B and P in the crucible that would not give any significant contamination to the silicon ingot. Some parts of the B and P compounds could be volatile and some parts would not be volatile due to some reasons. For example parts of B could be present as boron nitride which is not volatile. Therefore a series of tests were performed in order to find the limit of B and P that do not give any significant contamination to the silicon ingot.

### EXAMPLES

Several tests have been performed on different silicon nitride based crucibles and compared with a reference Si-ingot made in a fused silica crucible. The reference Si-ingot made in a traditional fused silica crucible is referred to as the reference Si-ingot in the following examples.

Test 1:
A Si-ingot has been made by using crucible A produced
from Silgrain ®, which according to the analysis (ICP)
possesses the following composition:

| Unit | Element | Analysis |
|---|---|---|
| weight % | Al | 0.16 |
| weight % | Ca | 0.011 |
| weight % | Fe | 0.022 |
| ppmw | Ti | 13 |
| ppmw | B | 19 |
| ppmw | P | 12 |

The Si-ingot was analysed by GDMS. The boron (B) and phosphorus (P) content of the Si-ingot prepared by using crucible A were significant higher than of the reference Si-ingot. Other elements of the Si-ingot prepared by using crucible A had normal values compared to the reference Si-ingot. The results of test 1 show that small amounts of B and P in a nitride based crucible will contaminate the Si-ingot. Other elements even present in relative high amounts, do not contaminate the Si-ingot.

Test 2:
One Si-ingot has been made using crucible B.
Crucible B has the following composition:

| Unit | Element | Analysis |
|---|---|---|
| weight % | Al | 0.001 |
| weight % | Ca | 0.01 |
| weight % | Fe | 0.2 |
| ppmw | Ti | 10 |
| ppmw | B | 1 |
| ppmw | P | 4.4 |

This Si-ingot had same content of B as the reference. The P content was significant higher than the reference. All other common elements were similar to the reference. This shows that B content of 1 ppmw and lower in the crucible does not cause any contamination to the Si-ingot.

Test 3:
One Si-ingot has been made using crucible C.
Crucible C has the following composition:

| Unit | Element | Analysis |
|---|---|---|
| weight % | Al | 0.0005 |
| weight % | Ca | 0.001 |
| weight % | Fe | 0.3 |
| ppmw | Ti | 5 |
| ppmw | B | <1 |
| ppmw | P | 3.7 |

This Si-ingot had same content of B as the reference. The P content was significant higher than the reference. All other common elements were similar to the reference. This show that B content of <1 ppmw in the crucible does not cause any contamination to the Si-ingot.

Test 4:
One Si-ingot has been made using crucible D.
Crucible D has the following composition:

| Unit | Element | Analysis |
|---|---|---|
| weight % | Al | 0.0005 |
| weight % | Ca | 0.001 |
| weight % | Fe | 0.2 |
| ppmw | Ti | 5 |
| ppmw | B | <1 |
| ppmw | P | <0.5 |

This Si-ingot had same content of B and P as the reference. All other common elements were similar to the reference. This shows that a B content of <1 ppmw and a P content of <0.5 in the crucible do not cause any contamination to the Si-ingot

1. A reusable silicon nitride containing crucible for crystallizing silicon, comprising:
at least one of boron or a boron containing compound in a concentration of less than 19 ppmw; and
at least one of phosphorous or a phosphorous containing compound in a concentration of less than 3.7 ppmw.

2. The reusable silicon nitride containing crucible according to claim 1, wherein the concentration of the at least one of phosphorous or the phosphorous containing compound is less than 0.5 ppmw.

3. The reusable silicon nitride containing crucible according to claim 1, wherein the concentration of the at least one of boron or the boron containing compound is less than or equal to 1 ppmw.

4. A method for preparing a crucible for crystallizing silicon, the method comprising preparing a silicon nitride composition comprising at least one of boron (B) or a boron containing compound in a concentration of less than 19 ppmw; and at least one of phosphorous (P) or a phosphorous containing compound in a concentration of less than 3.7 ppmw.

5. The method according to claim 4, wherein the at least one of boron or the boron containing compound is in a concentration of less than or equal to 1 ppmw.

6. The method according to claim 4, wherein the at least one phosphorous or the phosphorous containing compound is in a concentration of less than 0.5 ppmw.
